(19) United States
(12) Patent Application Publication
(10) Pub. No.: US 2026/0269435 A1
(43) Pub. Date: Sep. 10, 2026

(54) BATTERY MODULE

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Kosuke MAEDA, Mie (JP); Shun TAKAMIZAWA, Mie (JP); Yoshikazu SASAKI, Mie (JP)

(21) Appl. No.: 19/167,845

(22) PCT Filed: Mar. 30, 2023
(86) PCT No.: PCT/JP2023/013392

§ 371 Date: Sep. 23, 2025

(51) Int. Cl. H01M 50/569; H01M 50/204; H01M 50/258; H01M 50/262; H01M 50/289; H01M 50/507; H01M 50/51; H01M 50/512; H01M 50/519

(52) U.S. Cl. CPC H01M 50/569; H01M 50/204; H01M 50/258; H01M 50/262; H01M 50/289; H01M 50/507; H01M 50/51; H01M 50/512; H01M 50/519

(57) ABSTRACT

A battery module includes: a plurality of battery cells; a pair of electrode tabs provided on each of the battery cells; and a plurality of bus bars that form a current path that connects the plurality of battery cells, wherein the plurality of battery cells are disposed so as to be aligned, when a first direction is an arrangement direction of the plurality of battery cells, the pair of electrode tabs protrude in a second direction that intersects the first direction, and the plurality of bus bars extend in a third direction that intersects the second direction in a plane constituting the second direction, and each include a coupling part on at least one of opposite sides in the third direction.

### TECHNICAL FIELD

The present disclosure relates to a battery module.

### BACKGROUND

Patent Documents 1 to 3 disclose battery modules in each of which a plurality of chargeable and dischargeable battery cells are arranged in one direction, and electrode terminals of the adjacent battery cells are connected to each other by connecting members made of metal. In all of the documents, a voltage detection wire is connected, by welding, soldering or the like, to the connecting members that interconnect the electrode terminals, thus allowing the voltage state of the battery module to be monitored.

### PRIOR ART DOCUMENT

### Patent Document

Patent Document 1: JP 2014-127229 A
Patent Document 2: JP 2019-169427 A
Patent Document 3: JP 2022-083610 A

### SUMMARY OF THE INVENTION

### Problems to be Solved

However, all of Patent Documents 1 to 3 require the connecting members that interconnect the electrode terminals of the battery cells, and the voltage detection wire that is separate from the connecting members. This results in an increased number of components, and also an increased number of man-hours since an operation such as welding for connecting the connecting members to wires is also required.

Therefore, a battery module that can reduce the number of components and the number of man-hours is disclosed.

### Means to Solve the Problem

A battery module according to the present disclosure is a battery module including: a plurality of battery cells; a pair of electrode tabs provided on each of the plurality of battery cells; and a plurality of bus bars configured to be connected to the electrode tabs to form a current path that connect the plurality of battery cells, wherein the plurality of battery cells are disposed so as to be aligned, when a first direction is an arrangement direction of the plurality of battery cells, the pair of electrode tabs protrude in a second direction that intersects the first direction, the plurality of bus bars extend in a third direction that intersects the second direction in a plane constituting the second direction, and each include a coupling part on at least one of opposite sides thereof in the third direction, and, when the plurality of battery cells are disposed so as to be aligned, the plurality of bus bars form the current path, and a voltage detection path part is formed, via the coupling parts.

### Effect of the Invention

According to the present disclosure, it is possible to provide a battery module that can reduce the number of components and the number of man-hours.

### BRIEF DESCRIPTION OF THE DRAWINGS

FIG. 1 is a perspective view showing a battery module according to Embodiment 1.

FIG. 2 is a plan view of the battery module shown in FIG. 1.

FIG. 3 is an enlarged vertical cross-sectional view taken along the line III-III in FIG. 2.

FIG. 4 is a cross-sectional view taken along the line IV-IV in FIG. 2.

FIG. 5 is an enlarged vertical cross-sectional view taken along the line V-V in FIG. 2.

FIG. 6 is an exploded perspective view showing the battery module shown in FIG. 1 in a partially exploded state.

FIG. 7 is a perspective view showing a battery cell and an accommodation case constituting the battery module shown in FIG. 1 in an opposed state before assembly.

FIG. 8 is a plan view of the accommodation case shown in FIG. 7.

FIG. 9 is a plan view showing a battery module according to Embodiment 2.

FIG. 10 is an enlarged vertical cross-sectional view taken along the line X-X in FIG. 9.

FIG. 11 is a cross-sectional view taken along the line XI-XI in FIG. 9.

FIG. 12 is an enlarged vertical cross-sectional view taken along the line XII-XII in FIG. 9.

### DETAILED DESCRIPTION TO EXECUTE THE INVENTION

### Description of Embodiments of the Present Disclosure

First, aspects of the present disclosure will be listed and described.

(1) A battery module according to the present disclosure is a battery module including: a plurality of battery cells; a pair of electrode tabs provided on each of the plurality of battery cells; and a plurality of bus bars configured to be connected to the electrode tabs to form a current path that connect the plurality of battery cells, wherein the plurality of battery cells are disposed so as to be aligned, when a first direction is an arrangement direction of the plurality of battery cells, the pair of electrode tabs protrude in a second direction that intersects the first direction, the plurality of bus bars extend in a third direction that intersects the second direction in a plane constituting the second direction, and each include a coupling part on at least one of opposite sides thereof in the third direction, and, when the plurality of battery cells are disposed so as to be aligned, the plurality of bus bars form the current path, and a voltage detection path part is formed, via the coupling parts.

The battery module according to the present aspect uses the battery cell having a configuration in which the pair of electrode tabs protrude on opposite sides in the second direction (e.g., the left-right direction) that is orthogonal to the first direction (e.g., up-down direction) that is the arrangement direction of the plurality of battery cells. The plurality of bus bars that form the current path that connect the plurality of battery cells extend in the third direction that intersects the second direction on a plane constituting the second direction, and each include the coupling part on at least one side in the third direction. When the plurality of cells are disposed so as to be aligned, the plurality of bus bars are coupled via the coupling parts, whereby the current path that connects the plurality of battery cells in series or in parallel is formed, and the voltage detection path part is formed. That is, with the battery module according to the present aspect, the current path that interconnects the plurality of battery cells, and the voltage detection path part that performs voltage detection of the battery cells can be formed by the bus bars. Therefore, unlike conventional structures, it is not necessary to separately provide a voltage detection line for detecting the voltage, in addition to inter-electrode connection bus bars that interconnect the electrodes of the battery cells, and to achieve connection to the inter-electrode connection bus bars by welding or the like. As a result, it is possible to provide a battery module that can reduce the number of components and the number of man-hours.

(2) In (1) above, it is preferable that the bus bars are connected to the electrode tabs such that a width direction of the bus bars is the second direction, and a length of the bus bars in the second direction is greater than or equal to a length of the electrode tabs throughout the entire length of the bus bars. Since the length of the bus bars connected to the electrode tabs in the second direction is less than or equal to the length of the electrode tabs in the second direction throughout the entire length, the bus bars do not protrude outward from the electrode tabs in the second direction. Thus, the bus bars do not protrude from the battery cells in a projection of the battery cells in the arrangement direction. This enables the bus bars to be accommodated within the arrangement region of the battery cells, thus making it possible to reduce the size of the electrode module.

(3) In (1) or (2) above, it is preferable that at least one of the plurality of bus bars includes the voltage detection path part on the one side or the other side of the opposite sides in the third direction, the bus bars each include a tab connection part located between the opposite sides in the third direction and configured to be connected to the corresponding electrode tab, and a portion between the tab connection part and the voltage detection path part of the bus bar provided with the voltage detection path part is bent in a plate thickness direction, and the voltage detection path part protrudes forward in the first direction. By bending a portion of each of the bus bars that is located on the voltage detection path part side relative to the tab connection part, the voltage detection path part can protrude forward in the first direction. Accordingly, the space in the arrangement direction (first direction) of the plurality of battery cells can be effectively used to efficiently route the voltage detection path part, thus making it possible to reduce the size of the battery module.

(4) In any one of (1) to (3) above, it is preferable that the battery module further includes a circuit board to which the voltage detection path part is configured to be conductively connected, wherein the circuit board is disposed forward of the battery cell located most forward in the first direction, and an external connection part provided at an end portion of the voltage detection path part on a front side in the first direction is connected to a conductive path of the circuit board. In the case of forming a battery module including a circuit board to which the voltage detection path part is connected, the circuit board can be disposed adjacent, in the first direction, to the battery cell located most forward in the arrangement direction (first direction) of the battery cells. Furthermore, the external connection part can be provided at an end portion of the voltage detection path part of each of the bus bars in the first direction, and can be conductively connected to the circuit board directly by soldering or the like. Accordingly, a battery module including a circuit board constituting a control circuit or the like for use in voltage control or the like can be efficiently formed with a fewer number of components and a simple process.

(5) In (4) according to (3) or (3) above, it is preferable that each of the bus bars is provided with a crank bent portion between the coupling part and the tab connection part in the longitudinal direction, and the coupling part is spaced apart from the tab connection part in the first direction by the crank bent portion. With a simple structure in which the crank bent portion is provided between the tab connection part and the coupling part of each of the bus bars, the coupling part can be spaced apart from the tab connection part in the first direction. Since the first direction is the thickness direction of the battery cells, the position of the coupling part can be disposed in proximity to the adjacent battery cell, compared with the tab connection part located at a central portion of the battery cell in the thickness direction, or located near the center relative to opposite ends in the thickness direction. Therefore, the coupling parts of the bus bars respectively connected the electrode tabs of the adjacent battery cells can be easily brought close to each other, thus making is possible to improve the workability when coupling the coupling parts to each other directly by welding or the like.

(6) In any one of (3), (4) or (5) according to (3), it is preferable that the battery module further includes a plurality of insulating accommodation cases that separately accommodate the plurality of battery cells, wherein the accommodation cases each include: a body accommodating recess including a bottom wall opposed to a body part of the corresponding battery cell in the first direction so as to be open forward in the first direction; a pair of side wall parts provided on opposite sides of the corresponding body accommodating recess in the second direction; a pair of tab placement holes that penetrate the pair of side wall parts in the first direction and in which the pair of electrode tabs protruding on opposite sides of the body part accommodated in the body accommodating recess are placed, and coupling through holes that penetrate the pair of side wall parts in the first direction and in which the coupling parts of the bus bars are placed, a portion of each of the bus bars is held in embedded on the corresponding side wall part, and the coupling part of the bus bar placed in the coupling through hole is exposed on at least one of opposite surfaces of the side wall part in the first direction, the tab connection parts of the bus bars are placed in the tab placement holes of the side wall parts so as to be located inward of the opposite surfaces in the first direction, and the electrode tabs placed in the tab placement holes are overlapped with and connected to the tab connection parts, and, as a result of the plurality of accommodation cases being overlapped and assembled together in the first direction, the coupling parts of the plurality of bus bars are overlapped with and connected to each other in the first direction to form the current path.

The body of each of the battery cells is accommodated in the body accommodating recess of the corresponding accommodation case that includes e bottom wall. The electrode tabs of each of the battery cells are placed in the tab placement holes penetrating the side wall parts of the corresponding accommodation case in the first direction, and are connected to the tab connection parts of the corresponding bus bar that are located inward of the opposite surfaces of the side wall parts in the first direction and exposed inside the tab placement hole. The coupling parts of the bus bars are exposed on at least one of the opposite surfaces of the side wall parts of the accommodation cases. As a result of the accommodation cases in which the battery cells are accommodated in this manner being overlapped and assembled together in the first direction, the coupling parts exposed in the accommodation cases are overlapped with and connected to each other in the first direction, whereby the current path can be formed. That is, as a result of the accommodation cases being overlapped with each other in the first direction, the coupling parts that are overlapped with each other in the first direction are exposed to the outside via the respective coupling through holes. Accordingly, for example, when two accommodation cases are overlapped with each other, the coupling parts overlapped with each other in the first direction can be accessed through the coupling through holes, thus making it possible to perform a connection process such as welding or soldering. On the side wall parts of the accommodation cases, the bus bars are embedded in portions other than the tab connection parts and the coupling parts that require an electrical connection process. Therefore, the plurality of bus bars connected to the pair of electrode tabs can be handled as a single piece. Moreover, since the bus bars are positioned relative to the cases, a connection operation between the bus bar and the electrode tab, and a connection operation between the coupling parts can be performed easily, thus making it possible to improve the workability.

(7) In any one of (1) to (6) above, it is preferable that the plurality of battery cells are connected in series, a power input bus bar including a power input part is connected to one of the electrode tabs of the battery cell disposed most rearward in the first direction, a power output bus bar including a power output part is connected to one of the electrode tabs of the battery cell located most forward in the first direction, the plurality of bus bars include a plurality of intermediate bus bar that form a path that interconnects the power input bus bar and the power output bus bar of the current path, and at least one of the intermediate bus bars includes the coupling part on one of the opposite sides, and includes the voltage detection path part on the other of the opposite sides.

In a case where the plurality of battery cells are connected in series, the power input bus bar including the power input part to which an external wire and a circuit board are connected to one of the electrode tabs of the battery cell disposed most rearward in the first direction, and the power output bus bar including the power output part to which an external wire and a circuit board are connected is connected to one of the electrode tabs of the battery cell disposed most forward in the first direction. Also, the intermediate bus bars are connected to the current paths and the plurality of electrode tabs are coupled therebetween, and the plurality of battery cells can be connected in series by sequentially coupling the coupling parts of the adjacent intermediate bus bars to each other. In particular, by providing the voltage detection path parts on the intermediate bus bar such that respective potentials at connection portions of the adjacent battery cells can be obtained, it is possible to achieve more accurate voltage monitoring and control.

(8) In any of (1) to (6) above, it is preferable that the plurality of battery cells are connected in parallel, the plurality of bus bars include two end bus bars constituting opposite end portions of the current path, and a plurality of intermediate bus bars that form a path that interconnects the end bus bars of the current path, each of the end bus bars includes the coupling part and an external connection part on one of the opposite sides, and includes a voltage detection path part on the other of the opposite sides, the intermediate bus bars connected to the pair of the electrode tabs of the battery cell disposed most rearward in the first direction each include the coupling part on one of the opposite sides, and the other intermediate bus bars each include the coupling part on one of the opposite sides, and also include the coupling part on the other of the opposite sides.

In a case where the plurality of battery cells are connected in parallel, the end bus bars are connected to the electrode tabs on both sides of the battery cell disposed most forward in the first direction, and one of the external connection parts functions as the power input part, and the other external connection part functions as the power output part. Also, the intermediate bus bars connected to the pair of electrode tabs of the battery cell disposed most rearward in the first direction each include the coupling part on one of the opposite sides, and the other intermediate bus bars each include the coupling parts on the opposite ends. As a result of the coupling parts provided on the intermediate bus bars being overlapped with and connected to each other in the first direction, the plurality of battery cells can be connected in parallel. By simply using the intermediate bus bars and the two end bus bars, the current path in which the plurality of battery cells are connected in parallel can be easily constructed, and the voltage can be stably detected by the end bus bars on two sides constituting the power input unit side and the power output side, thus making it also possible to shorten the voltage detection path.

### Details of Embodiments of the Present Disclosure

Specific examples of the battery module according to the present disclosure will be described below with reference to the drawings. It should be noted that the present disclosure is not limited to these examples, but is defined by the claims, and is intended to include all modifications which fall within the scope of the claims and the meaning and scope of equivalents thereof.

### Embodiment 1

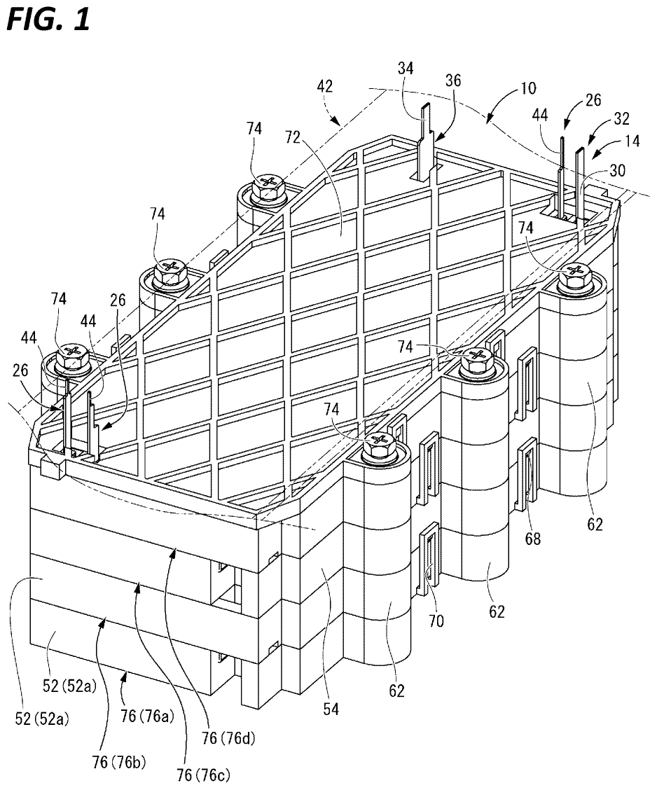

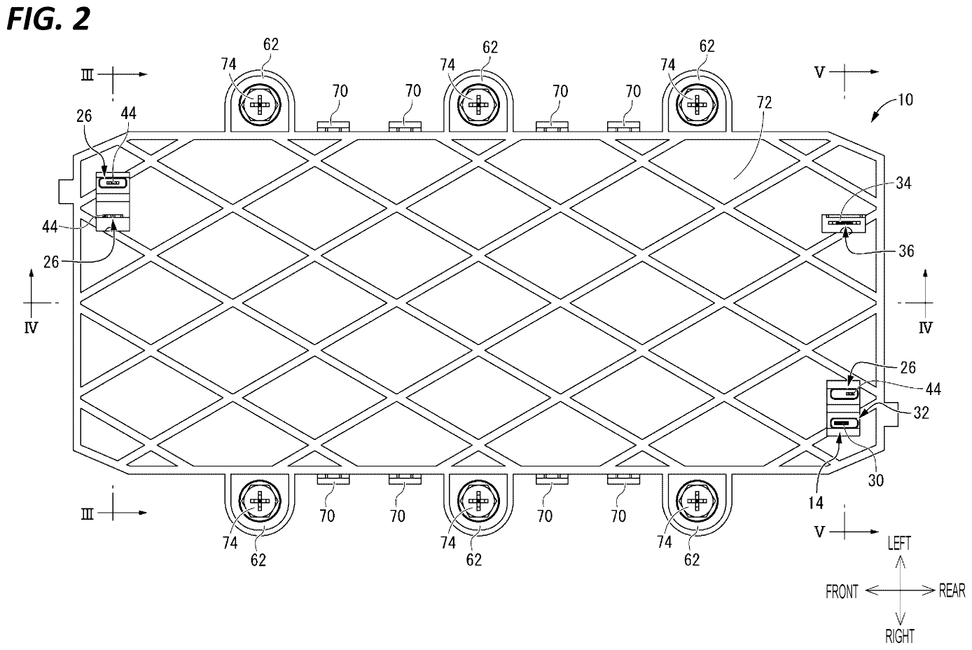

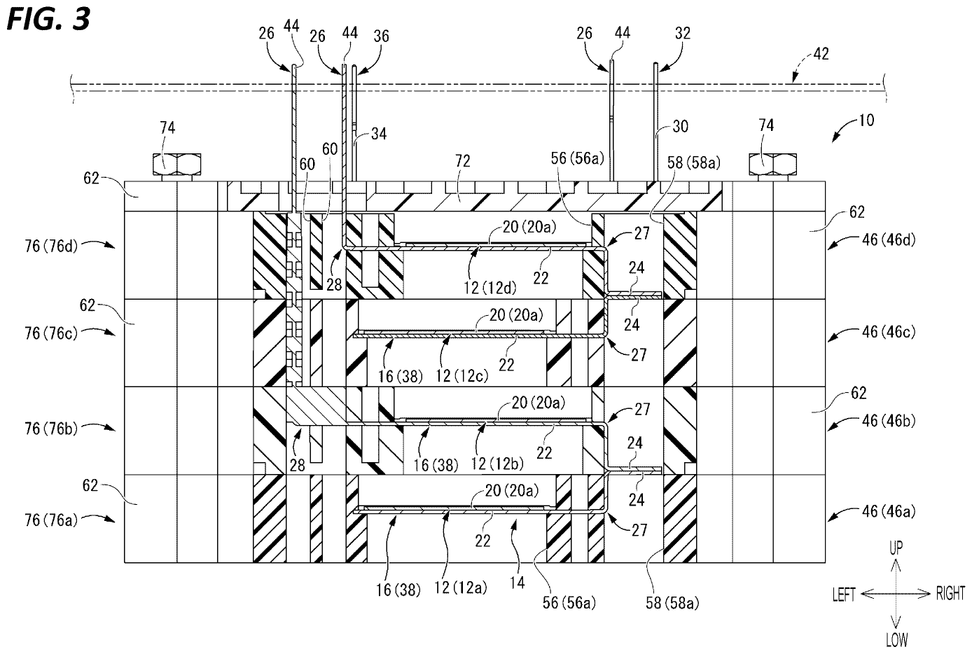

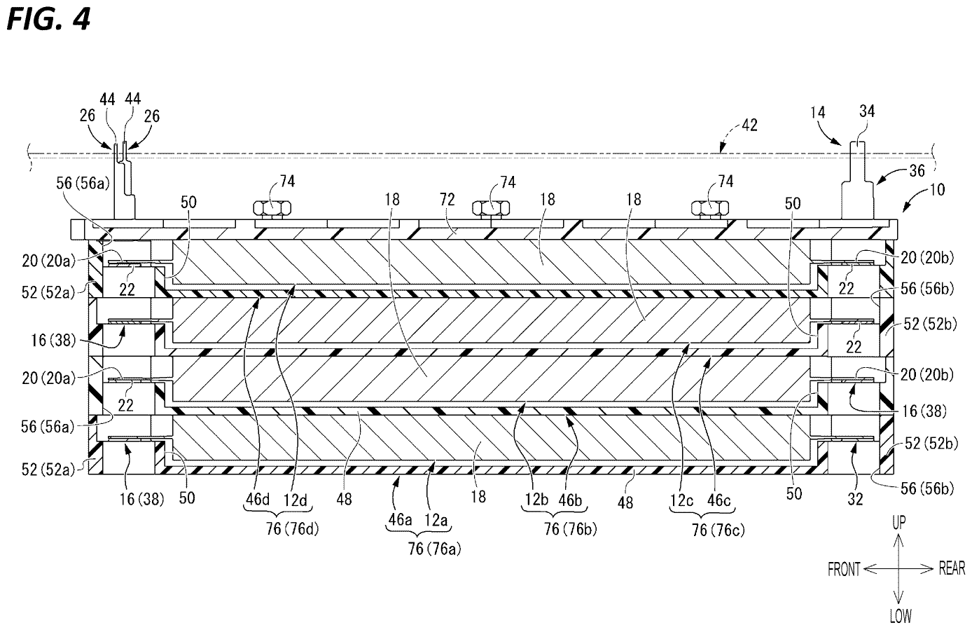

A battery module 10 according to Embodiment 1 of the present disclosure will be described below with reference to FIGS. 1 to 8. A battery module 10 according to Embodiment 1 is used, for example, as a driving source for a vehicle such as an electric automobile and a hybrid vehicle, and has a structure in which a plurality of chargeable and dischargeable battery cells 12 are arranged. Note that, while the battery module 10 can be disposed in any orientation, the following description assumes that the upper side refers to the upper side in FIG. 3, the lower side refers to the lower side in FIG. 3, the left side refers to the left side in FIG. 3, the right side refers to the right side in FIG. 3, the front side refers to the left side in FIG. 2, and the rear side refers to the right side in FIG. 2. For a plurality of identical members in the following description, reference numerals may be assigned to some of the members, and reference numerals may be omitted for the other members.

### Battery Module 10

The battery module 10 includes a plurality of chargeable and dischargeable battery cells 12 arranged in the up-down direction, which is a first direction, and a plurality of bus bars 16 that interconnect the plurality of battery cells 12 to form current paths 14. In Embodiment 1, the battery module 10 includes four battery cells 12 (first to fourth battery cells 12a to 12d in this order from the lower side). In the following description, the front side in the first direction refers to a direction from the lower side to the upper side, and the rear side in the first direction refers to direction from the upper side to the lower side.

### Battery Cells 12 (First to Fourth Battery Cells 12a to 12d)

The battery cells 12 (first to fourth battery cells 12a to 12d) have the same shape with each other, and has a plate shape that is overall flat and has a predetermined width and length. For example, a known capacitor (a power storage element) or the like can be used as each of the battery cells 12a to 12d, and therefore the description of the specific structure has been omitted. Each of the battery cells 12a to 12d includes a plate-shaped body part 18 formed in a square shape having a predetermined width and length in a plan view, and a pair of electrode tabs 20 and 20 (a front electrode tab 20a and a rear electrode tab 20b) protruding from the body part 18 to opposite sides in a second direction that intersects the first direction (up-down direction) That is, in each of the battery cells 12a to 12d, one of the front electrode tab 20a and the rear electrode tab 20b is a positive electrode (+ electrode), and the other is a negative electrode (− electrode). In Embodiment 1, the battery cells 12a to 12d are connected in series by the plurality of bus bars 16.

The body part 18 of each of the battery cells 12a to 12d extends in a horizontal direction that is orthogonal to a stacking direction (up-down direction) in which the battery cells 12a to 12d are arranged, and is disposed in an orientation in which the dimension in the front-rear direction is larger than the dimension in the left-right direction in the assembled state of the battery module 10 in particular. From opposite end portions in the front-rear direction of each of the body parts 18, the two electrode tabs 20a and 20b respectively protrude to the opposite sides in the front-rear direction. In Embodiment 1, the second direction that is the protruding direction of the electrode tabs 20a and 20b is the front-rear direction, which is a direction orthogonal to the first direction (up-down direction). Each of the electrode tabs 20a and 20b has a predetermined dimension in the left-right direction.

### Bus Bar 16

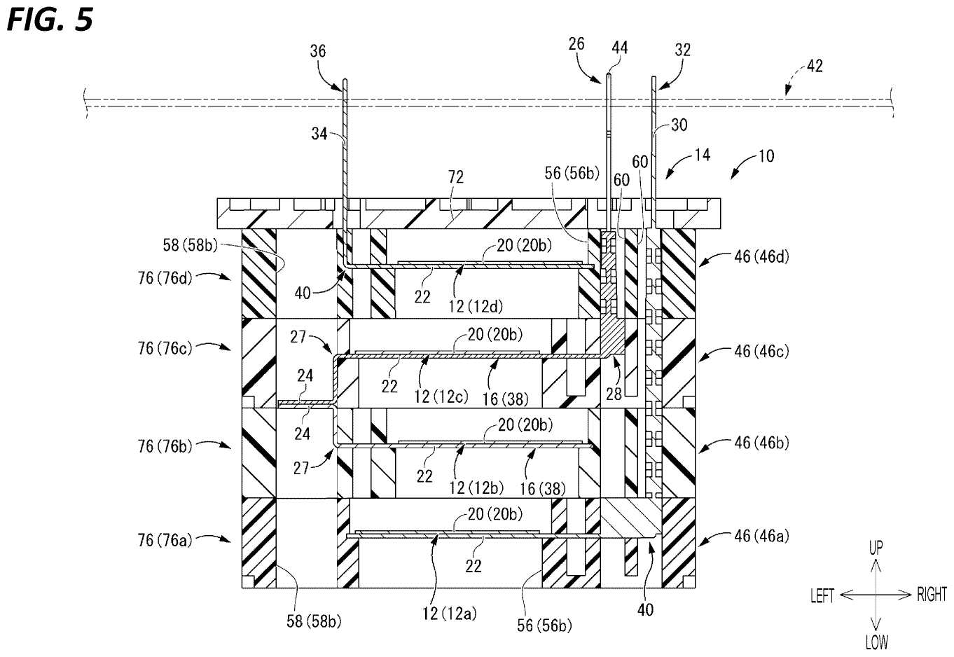

Although the plurality of bus bars 16 are slightly different from each other, they generally have shapes similar to each other, and are formed by bending a band-shaped metal plate extending with a predetermined width dimension by press working or the like. Each of the bus bars 16 includes a tab connection part 22 provided between opposite ends thereof in the longitudinal direction, which is a third direction (the left-right direction in FIGS. 3 and 5) that intersects the second direction in a plane constituting the second direction, and the tab connection part 22 of each of the bus bars 16 is connected to the electrode tabs 20a and 20b of the corresponding one of the battery cells 12a to 12d. Note that, the plurality of bus bars 16 in the present disclosure couple the electrode tabs 20 of one of the battery cells 12 adjacent to each other on the current path 14 to the electrode tabs 20 of the other battery cell 12, and not to include bus bars (a power input bus bar 32 and a power output bus bar 36 described later) that are connected to one of the electrode tabs 20 of each of the battery cells 12 for input and output of power. That is, the battery module 10 in Embodiment 1 is provided with a total of eight bus bars, and six bus bars other than the power input bus bar 32 and the power output bus bar 36 are the plurality of bus bars 16 that interconnect the plurality of battery cells 12 to form the current path 14.

In the assembled state of the battery module 10, the electrode tabs 20a and 20b protrude to the opposite sides in the front-rear direction as described above, and the bus bars 16 are disposed so as to extend in the left-right direction, which is the third direction that is orthogonal to the front-rear direction and the up-down direction, and that intersects the second direction in the plane constituting the front-rear direction, which is the second direction. Therefore, in Embodiment 1, each of the tab connection parts 22 is provided in the left-right direction of the corresponding bus bar 16 at an intermediate portion of the bus bar 16 in the left-right direction. The width direction of the bus bars 16 is the above-described second direction (front-rear direction), and the bus bars 16 each have a predetermined dimension in the width direction (a dimension in the front-rear direction).

Accordingly, the tab connection parts 22 of the bus bars 16 each have a predetermined dimension in the left-right direction and a predetermined dimension in the front-rear direction. Also, as will be described later, the electrode tabs 20a and 20b and the corresponding tab connection part 22 are overlapped with and connected to each other, and the electrode tabs 20a and 20b and the corresponding tab connection part 22 are connected with a sufficient dimension in the left-right direction. In a state in which the electrode tabs 20a and 20b and the corresponding tab connection part 22 are overlapped with each other, the tab connection part 22 does not protrude outward from the electrode tabs 20a and 20b in the second direction (front-rear direction). That is, each of the tab connection parts 22 is connected to the corresponding electrode tabs 20a and 20b such that the width direction of the bus bars 16 coincides with the second direction, and the length of the bus bars 16 in the second direction is greater than or equal to the length of the electrode tabs 20a and 20b throughout the entire length of the bus bars 16. Therefore, in Embodiment 1, the bus bars 16 are configured not to protrude outward of the electrode tabs 20a and 20b in the front-rear direction throughout the entire length thereof.

Furthermore, each of the bus bars 16 (intermediate bus bars 38 described later) includes a coupling part 24 on at least one of opposite sides (in the left-right direction), and the coupling parts 24 and 24 that are adjacent to each other are electrically conductively coupled to each other during assembly of the battery module 10, whereby the above-described current path 14 is formed. The coupling parts 24 are formed with a predetermined dimension in the left-right direction. At least one of the bus bars 16 (intermediate bus bars 38 described later) includes a voltage detection path part 26 is provided by a side of the bus bar 16 (in the left-right direction) on which the coupling part 24 is not provided (the other side of the opposite sides).

In Embodiment 1, a crank bent portion 27 is provided between the coupling part 24 and the tab connection part 22 of each of the bus bars 16 (in the left-right direction). By the crank bent portion 27, the coupling part 24 is spaced apart from the tab connection part 22 in the first direction (up-down direction). That is, the bus bar 16 including the coupling part 24 has a portion that extends in the up-down direction by an intermediate portion thereof in the left-right direction being bent in a crank shape, and the coupling part 24 and the tab connection part 22 are connected with each other by the portion extending in the up-down direction. As a result, the coupling part 24 is located upward or downward of the tab connection part 22.

In Embodiment 1, each of the bus bars 16 including the voltage detection path part 26 is provided with a bent portion 28 that is bent in the plate thickness direction of the bus bar 16 between the tab connection part 22 and the voltage detection path part 26. Accordingly, the voltage detection path parts 26 are bent in the plate thickness direction of the bus bars 16 relative to the tab connection parts 22 extending in the left-right direction, and the voltage detection path parts 26 protrude toward the upper side that is the front side in the first direction. Each of the voltage detection path parts 26 has a predetermined dimension in the up-down direction. Note that, as shown in FIG. 3 and FIG. 5 as well, some of the bus bars 16 each including the voltage detection path part 26 may have a larger thickness at the bent portion 28 than the thickness at the other portions, or may have a constant thickness dimension throughout the entire length of the bus bars 16.

Also, as shown in FIG. 3 as well, in a case where a plurality of voltage detection path parts 26 are provided on one side (the front side in Embodiment 1) of the battery module 10 in the front-rear direction, the plurality of voltage detection path parts 26 are provided at positions spaced apart from each other in the left-right direction. That is, since the plurality of bus bars 16 provided with the voltage detection path parts 26 are provided with the bent portions 28 at different positions in the left-right direction, the plurality of voltage detection path parts 26 on one side of the battery module 10 in the front-rear direction are provided at positions spaced apart from each other in the left-right direction.

In Embodiment 1, a power input bus bar 32 including a power input part 30 is connected to one electrode tab 20 (the rear electrode tab 20b) of the battery cell 12 (the first battery cell 12a) disposed on the rearmost side (lowermost) in the first direction. A power output bus bar 36 including a power output part 34 is connected to one electrode tab (rear electrode tab 20b) of the battery cell 12 (the fourth battery cell 12d) disposed on most forward (uppermost) in the first direction. That is, among eight bus bars that connect the battery cells 12a to 12d in series, the bus bar located lowermost and rearmost constitutes the power input bus bar 32, and the bus bar located uppermost and rearmost constitutes the power output bus bar 36. Also, the bus bars 16 that form a path connecting the power input bus bar 32 to the power output bus bar 36 constitute the intermediate bus bars 38. In short, of the eight bus bars, the six bus bars 16 other then the power input bus bar 32 and the power output bus bar 36 constitute the intermediate bus bars 38.

Note that, similarly to the bus bars 16, the power input bus bar 32 and the power output bus bar 36 are also each formed by bending a band-shaped metal plate extending with a constant width dimension by press working or the like, and a tab connection part 22 is the same as the those of the bus bars 16 is formed at one end portion of each of the power input bus bar 32 and the power output bus bar 36 in the left-right direction. Also, the power input part 30 and the power output part 34 are respectively formed at other end portions of the power input bus bar 32 and the power output bus bar 36 in the left-right direction.

A bent portion 40 that is the same as those of the bus bars 16 (the intermediate bus bars 38) provided with the voltage detection paths part 26 are provided on the power input bus bar 32 between the tab connection part 22 and the power input part 30. On the power output bus bar 36 as well, a bent portion 40 is provided between the tab connection part 22 and the power output part 34. Accordingly, each of the power input part 30 and the power output part 34 protrudes toward the upper side that is the front side in the first direction from the tab connection part 22 extending in the left-right direction. Each of the power input part 30 and the power output part 34 has a predetermined dimension in the up-down direction. The power input bus bar 32 and the power output bus bar 36 may have a larger thickness at the bent portions 40 than the thickness at the other portions. Note that, as described above, the power input part 30 and the power output part 34 are provided at the rear of the battery module 10, and the power input part 30, the power output part 34, and the voltage detection path part 26 on the rear side are spaced apart from each other in the left-right direction. Therefore, the bent portion 40 of the power input bus bar 32, the bent portion 40 of the power output bus bar 36, and the bent portion 28 of the bus bar 16 on the rear side are positions different from each other in the left-right direction.

In Embodiment 1, the voltages between the battery cells 12a to 12d are detected by the voltage detection path parts 26. Specifically, the voltage at three locations, namely, a location between the first battery cell 12a and the second battery cell 12b, a location between the second battery cell 12b and the third battery cell 12c, and a location between the third battery cell 12c and the fourth battery cell 12d are detected. Accordingly, on the current path 14, the three bus bars 16 (intermediate bus bars 38) constituting the above-described three locations are provided with the voltage detection path parts 26. More specifically, the intermediate bus bar 38 connected to the front electrode tab 20a of the second battery cell 12b, the intermediate bus bar 38 connected to the rear electrode tab 20b of the third battery cell 12c, the intermediate bus bar 38 connected to the front electrode tab 20a of the fourth battery cell 12d are each provided with the voltage detection path part 26.

### Circuit Board 42

The battery module 10 may include a circuit board 42 to which the voltage detection path parts 26 are conductively connected. The circuit board 42 is indicated by the dashed double-dotted line in the drawings. The circuit board 42 may be disposed forward (i.e., upward) in the first direction relative to, for example, the battery cell 12 (the fourth battery cell 12d) located most forward in the first direction. Also, the external connection parts 44 provided at end portions on the front side (upper side) of the respective voltage detection path parts 26 in the first direction may, for example, be passed through insertion holes provided in the circuit board 42, and be electrically connected, via solder or the like, to a conductive path of an electric circuit (not shown) provided on a surface (an upper surface and/or a lower surface) of the external connection parts 44 and the circuit board 42. Similarly, the power input part 30 of the power input bus bar 32 and the power output part 34 of the power output bus bar 36 may be passed through the circuit board 42, and the power input part 30 and the power output part 34 may be electrically connected to a conductive path of an electric circuit (not shown) of the circuit board 42.

### Accommodation Case 46

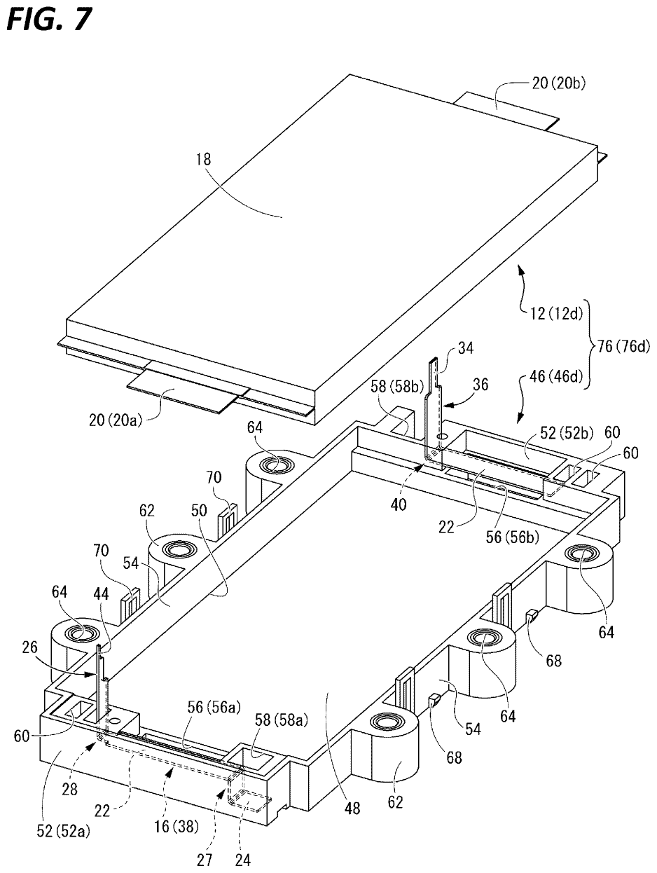

The battery module 10 includes a plurality of insulating accommodation cases 46 that separately accommodate the plurality of battery cells 12, respectively. Since the four battery cells 12 (first to fourth battery cells 12a to 12d) are provided in Embodiment 1, the battery module 10 includes four accommodation cases 46 (first to fourth accommodation cases 46a to 46d in this order from the lower side). Although the accommodation cases 46a to 46d are slightly different from each other, they generally have shapes similar to each other, and are each made of a synthetic resin. Note that an assembly 76, which will be described later, of the uppermost battery cell 12 and the corresponding accommodation case 46 (i.e., an assembly 76 (fourth assembly 76d) of the fourth battery cell 12d and the fourth accommodation case 46d) is shown in an exploded state in FIG. 7.

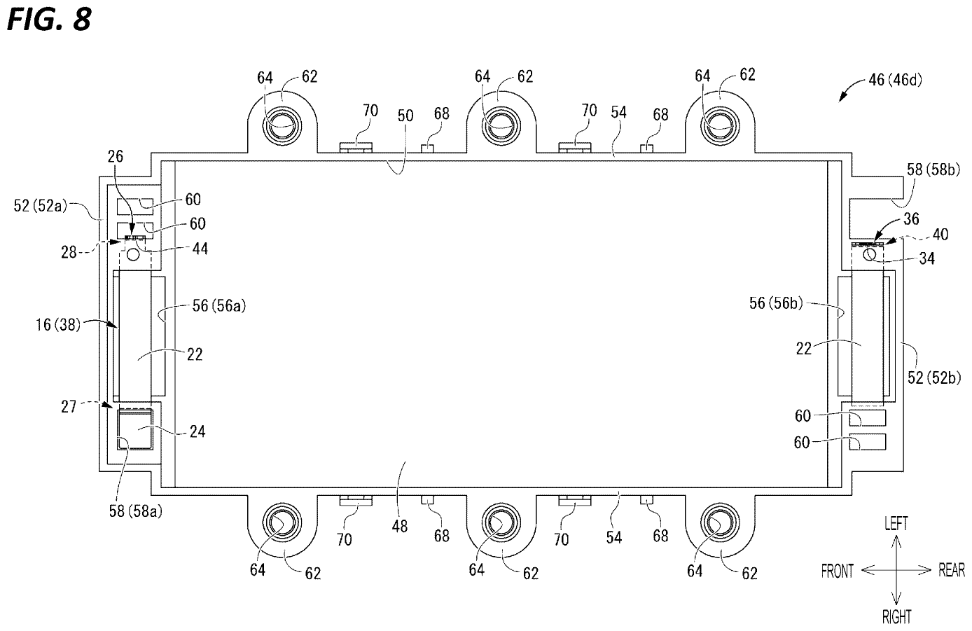

FIGS. 7 and 8 show the fourth accommodation case 46d as a specific example of the accommodation case 46. The accommodation cases 46a to 46d include: body accommodating recess 50 on which the body parts 18 of the battery cells 12a to 12d are respectively placed, or that include bottom walls 48 opposed to the corresponding body parts 18 in the first direction (up-down direction) with a gap therebetween so as to open forward (upward) in the first direction; and a pair of side wall parts 52 and 52 (a front side wall part 52a and a rear side wall part 52b) provided on opposite side of each of the body accommodating recesses 50 in the second direction (front-rear direction). The accommodation cases 46a to 46d each have a rectangular shape have a predetermined width and length in a plan view, ant the pair of side wall parts 52a and 52b are connected to each other by a pair of connection wall parts 54 and 54 provided on opposite sides of the body accommodating recess 50 in the third direction (i.e., the left-right direction) that is a direction orthogonal to the first and second directions. By the bottom wall 48, the pair of side wall parts 52a and 52b, and the pair of connection wall parts 54 and 54, each of the accommodation cases 46a to 46d is formed in the shape of an upwardly open box.

The side wall parts 52a and 52b include a pair of tab placement holes 56 and 56 (a front tab placement hole 56a and a rear tab placement hole 56b) in which the pair of electrode tabs 20a and 20b protruding on the opposite sides of the body part 18 accommodated in the corresponding body accommodating recess 50 are respectively placed. The tab placement holes 56a and 56b are provided to penetrate the side wall parts 52a and 52b, respectively, in the first direction (up-down direction). The tab placement holes 56a and 56b are formed in a substantially rectangular shape having a dimension in the front-rear direction larger than a dimension in the left-right direction in a plan view. Furthermore, the side wall parts 52a and 52b include a pair of coupling through holes 58 and 58 (a front coupling through hole 58a and a rear coupling through hole 58b) in which the coupling parts 24 of each of the bus bars 16 are respectively placed. The coupling through holes 58a and 58b are provided to penetrate the side wall parts 52a and 52b, respectively, in the first direction (up-down direction). The coupling through holes 58a and 58b are formed to have a rectangular shape in a plan view.

In Embodiment 1, the tab placement holes 56a and 56b are provided in intermediate portions of the side wall parts 52a and 52b in the left-right direction, and the coupling through holes 58a and 58b are formed on one side of the side wall parts 52a and 52b in the left-right direction relative to the tab placement holes 56a and 56b. At least one insertion holes 60 through which one of the voltage detection path part 26 provided on each of the bus bars 16, the power input part 30 provided on the power input bus bar 32, and the power output part 34 provided on the power output bus bar 36 is passed is formed on the other side of each of the side wall parts 52a and 52b in the left-right direction relative to the tab placement holes 56a and 56b. In Embodiment 1, two insertion holes 60 and 60 are provided in each of the side wall parts 52a and 52b so as to be spaced apart from each other in the left-right direction.

One of the bus bar 16, the power input bus bar 32, and the power output bus bar 36 is held on the side wall part 52a or 52b in a state in which a portion thereof is embedded in the side wall part 52a or 52b. On the side wall part 52a or 52b on which the bus bar 16 is held, the coupling part 24 of the bus bar 16 placed in the coupling through hole 58a or 58b is exposed on at least one of opposite surfaces (an upper surface and a lower surface) of the side wall part 52a or 52b in the first direction. In Embodiment 1, each of the accommodation cases 46a to 46d is molded in a state in which one of the bus bar 16, the power input bus bar 32, and the power output bus bar 36 is appropriately set in a molding cavity during used molding. Thus, each of the accommodation cases 46a to 46d has one of a configuration including one bus bar 16 and the power input bus bar 32, a configuration including a pair of bus bars 16 and 16, and a configuration including one bus bar 16 and the power output bus bar 36, and is molded in a single piece with the bus bar 16 or bus bars 16, the power input bus bar 32, and the power output bus bar 36.

Furthermore, the tab connection parts 22 of the bus bars 16, the power input bus bar 32, and the power output bus bar 36 are placed in the tab placement holes 56a and 56b of the side wall parts 52a and 52b. That is, the tab connection parts 22 of the bus bars 16, the power input bus bar 32, and the power output bus bar 36 are not embedded in the side wall parts 52a and 52b, and upper and lower surfaces of the tab connection parts 22 are exposed to the outside through the tab placement holes 56a and 56b. In a state in which the bus bars 16, the power input bus bar 32, and the power output bus bar 36 are held on the side wall parts 52a and 52b, the tab connection parts 22 are located inward of the opposite surfaces (upper and lower surfaces) of the side wall parts 52a and 52b in the first direction, and, in other words, are located at intermediate portions of the side wall parts 52a and 52b in the up-down direction.

As a specific example of the accommodation case 46, the fourth accommodation case 46d will be described with reference to FIGS. 7 and 8. In the fourth accommodation case 46d, a front coupling through hole 58a is formed in a right portion of the front side wall part 52a, and two insertion holes 60 and 60 are formed in left portions thereof. The voltage detection path parts 26 protruding upward from two bus bars 16 at the front of the battery module 10 are passed through the two insertion holes 60 and 60 at the front. A rear coupling through hole 58b is formed in a left portion of the rear side wall part 52b, and two insertion holes 60 and 60 are formed in right portions thereof. Of the two insertion holes 60 and 60 at the rear, the power input part 30 of the power input bus bar 32 is passed through the right insertion hole 60, and the voltage detection path part 26 protruding upward from one bus bar 16 at the rear of the battery module 10 is passed through the left insertion hole 60.

On the front side wall part 52a of the fourth accommodation case 46d, a portion of a bus bar 16 (intermediate bus bar 38) is held in an embedded state. As also shown in FIG. 3, a tab connection part 22 is provided at an intermediate portion of the bus bar 16 (intermediate bus bar 38) in the left-right direction, and a coupling part 24 is provided at a right portion thereof via a crank bent portion 27 from the tab connection part 22. The coupling part 24 is located below the tab connection part 22, and placed in the front coupling through hole 58a to be exposed on a lower surface of the fourth accommodation case 46d. A bent portion 28 is provided at a left portion of the bus bar 16, and a voltage detection path part 26 protrudes thereabove. The voltage detection path part 26 protrudes upward through the insertion hole 60 of the two insertion holes 60 and 60 provided in the front side wall part 52a. Also, the tab connection part 22 of the bus bar 16 is placed in the front tab placement hole 56a to be exposed to the outside.

A portion of the power output bus bar 36 is held in an embedded state on the rear side wall part 52b of the fourth accommodation case 46d. As also shown FIG. 5, on the power output bus bar 36, a bent portion 40 is provided at a left end portion of tab connection part 22 extending in the left-right direction, and a power output part 34 protrudes upward via the bent portion 40. The power output part 34 protrudes upward from the rear side wall part 52b between the rear tab placement hole 56b and the rear coupling through hole 58b in the left-right direction. Also, the tab connection part 22 of the power output bus bar 36 is placed in the rear tab placement hole 56b to be exposed to the outside.

Furthermore, at least one leg part 62 protruding outward in the left-right direction is provided on each of the connection wall parts 54 of the accommodation cases 46a to 46d. In Embodiment 1, three leg parts 62 are provided on each of the connection wall parts 54, and the leg parts 62 are spaced apart from each other in the front-rear direction. Note that, bolt insertion holes 64 penetrating in the up-down direction are formed in central portions of the leg parts 62 of the second to fourth accommodation cases 46b to 46d, and bolt holes 66 to which fixing bolts 74 described below are fastened are formed in central portions of the leg parts 62 of the first accommodation case 46a.

Lock pawl parts 68 and lock frame parts 70 are provided on the connection wall parts 54 of each of the second to fourth accommodation cases 46b to 46d between the leg parts 62 in the front-rear direction. Note that only the lock frame parts 70 are provided on the connection wall parts 54 of the first accommodation case 46a. The lock frame parts 70 protrude upward, and are engaged with the lock pawl parts 68 provided on an upwardly adjacent accommodation case 46.

In particular, in Embodiment 1, a lid member 72 is overlapped with the top of the fourth accommodation case 46d. On opposite sides of the lid member 72 in the left-right direction, the leg parts 62 including the bolt insertion holes 64 are provided at positions corresponding to the leg parts 62 of the accommodation cases 46a to 46d, and each of the lock pawl parts 68 is provided between the leg parts 62 in the front-rear direction.

During assembly of the battery module 10, the accommodation cases 46a to 46d are overlapped with each other in the up-down direction, the bolt insertion holes 64 and the corresponding bolt holes 66 are aligned with each other, and the fixing bolts 74 are passed therethrough and fastened to the bolt holes 66. The lock frame parts 70 provided on the fourth accommodation case 46d are engaged with the lock pawl parts 68 provided on the lid member 72.

### Assembly 76 of Battery Cell 12 and Accommodation Case 46

As described previously, the battery cells 12a to 12d are accommodated in the accommodation cases 46a to 46d and assembled together. That is, the battery cells 12a to 12d and the accommodation cases 46a to 46d are opposed and brought close to each other in the up-down direction as shown in FIG. 7 (only the fourth battery cell 12d and the fourth accommodation case 46d are illustrated as an example in FIG. 7). Thus, the body parts 18 of the battery cells 12a to 12d are accommodated in the corresponding body accommodating recess 50 of the accommodation cases 46a to 46d. The electrode tabs 20a and 20b of the battery cells 12a to 12d are overlapped from above with the tab connection parts 22 (the tab connection parts 22 of the bus bar 16 (intermediate bus bar 38) and the tab connection part 22 of the power output bus bar 36 in FIG. 7) exposed from the side wall parts 52a and 52b through the tab placement holes 56a and 56b, and are connected thereto by welding or the like. As a result, assemblies 76 of the battery cells 12 and the accommodation cases 46 are formed. Since the tab placement holes 56a and 56b penetrate in the up-down direction, a welding jig can be brought into contact with the overlapped portion of the tab connection parts 22 and the electrode tabs 20a and 20b from the upper and lower sides.

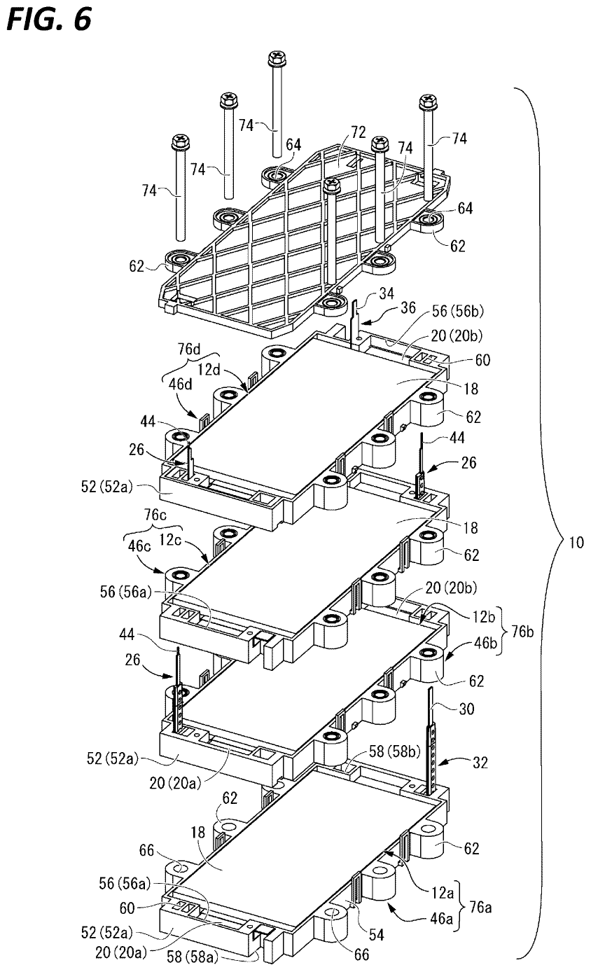

In Embodiment 1, as a result of the battery cells 12a to 12d being accommodated in the accommodation cases 46a to 46d, four assemblies 76 (first to fourth assemblies 76a to 76d in this order from the lower side) are formed as shown in FIG. 6. Note that, in a state in which the assemblies 76a to 76d are formed, the body parts 18 of the battery cell 12 may be overlapped with the bottom walls 48 of the accommodation cases 46a to 46d, or may be opposed with a gap therebetween in the up-down direction. In Embodiment 1, the body part 18 of each of the battery cells 12 is overlapped with the bottom wall 48 of an upwardly adjacent assembly 76, or the lid member 72 without any gap therebetween. In a state in which the assemblies 76a to 76d are formed, the bus bars 16 do not protrude outward of the electrode tabs 20a and 20b in the second direction (outward in the front-rear direction) throughout the entire length.

### Current Path 14

As described above, the assemblies 76a to 76d configured to include the accommodation cases 46a to 46d are overlapped with each other in the first direction (up-down direction), and the coupling parts 24 and 24 adjacent to each other of the bus bars 16 in the up-down direction are overlapped with and connected to each other, whereby the current path 14 is formed. The connection between the coupling parts 24 and 24 adjacent to each other in the up-down direction can be achieved, for example, by welding each of the coupling parts 24 and 24.

In Embodiment 1, the current path 14 is configured to include the power input bus bar 32, the first battery cell 12a, the bus bars 16 that connect the first battery cell 12a and the second battery cell 12b to each other, the second battery cell 12b, the bus bars 16 that connect the second battery cell 12b and the third battery cell 12c to each other, the third battery cell 12c, the bus bars 16 that connect the third battery cell 12c and the fourth battery cell 12d to each other, the fourth battery cell 12d, and the power output bus bar 36. Thus, the battery cells 12a to 12d are connected in series in Embodiment 1.

### Assembly Process of Battery Module 10

Next, a specific example of an assembly process of the battery module 10 will be described. Note that the assembly process of the battery module 10 is not limited to the following description.

First, the battery cells 12a to 12d are accommodated in the accommodation cases 46a to 46d, and the electrode tabs 20a and 20b and the corresponding tab connection parts 22 are overlapped with each other, and connected by being welded to each other. As described previously, the welding between the electrode tabs 20a and 20b and the tab connection parts 22 is achieved via the tab placement holes 56a and 56b penetrating in the up-down direction. Thus, the assemblies 76a to 76d are obtained.

Thereafter, the first assembly 76a and the second assembly 76b are overlapped with each other in the up-down direction. At this time, the lock frame parts 70 of the first assembly 76a and the corresponding lock pawl parts 68 of the second assembly 76b are engaged with each other, thus preventing positional displacement between the first assembly 76a and the second assembly 76b. Thus, as shown in FIG. 3, at front portions of the first assembly 76a and the second assembly 76b, the coupling parts 24 and 24 adjacent to each other in the up-down direction of the bus bars 16 are overlapped with each other in the up-down direction. The coupling parts 24 are disposed inside the corresponding front coupling through holes 58a penetrating in the up-down direction, and a welding jig can be inserted through the front coupling through holes 58a so as to be brought into contact with the overlapped portion of the coupling parts 24 and 24. Then, using the welding jig that has been inserted through the front coupling through holes 58a, the coupling parts 24 and 24 overlapped in the up-down direction are welded to each other. As a result, the first assembly 76a and the second assembly 76b are coupled to each other in the up-down direction. In the same manner, the third assembly 76c and the fourth assembly 76d are coupled to each other in the up-down direction.

Subsequently, the first and second assemblies 76a and 76b that have been coupled to each other, and the third and fourth assemblies 76c and 76d that have been coupled to each other are overlapped with each other in the up-down direction, and the lock frame parts 70 of the second assembly 76b and the corresponding lock pawl parts 68 of the third assembly 76c are engaged with each other. In this state, as shown in FIG. 5, at rear portions of the second assembly 76b and the third assembly 76c, the coupling parts 24 and 24 adjacent to each other in the up-down direction of the bus bars 16 are overlapped with each other in the up-down direction. The coupling parts 24 are disposed inside the corresponding rear coupling through holes 58b penetrating in the up-down direction, and a welding jig can be inserted through the rear coupling through holes 58b so as to be brought into contact with the overlapped portion of the coupling parts 24 and 24. Then, using the welding jig that has been inserted through the rear coupling through holes 58b, the coupling parts 24 and 24 that are overlapped with each other in the up-down direction are welded to each other. As a result, the first and second assemblies 76a and 76b that have been coupled to each other and the third and fourth assemblies 76c and 76d that have been coupled to each other are coupled to each other in the up-down direction.

Thereafter, the lid member 72 is brought closer to the fourth assembly 76d from thereabove, and the lock frame parts 70 of the fourth assembly 76d and the corresponding lock pawl parts 68 of the lid member 72 are engaged with each other. Then, the fixing bolts 74 are passed through the corresponding bolt insertion holes 64 of the leg parts 62 that have been aligned with each other, and fastened to the corresponding bolt holes 66. Thus, a battery module 10 is completed.

Note that the battery module 10 may include the circuit board 42. In a case where the circuit board 42 is provided, the circuit board 42 is disposed above the lid member 72, and the external connection parts 44 of the voltage detection path parts 26 are passed through the circuit board 42, and are electrically connected to the conductive path of the circuit board 42 with solder or the like. Thus, the voltage detection by the voltage detection path parts 26 is performed according to an electric circuit or the like formed on the circuit board 42. In Embodiment 1, as described previously, voltages at three locations, namely, a location between the first battery cell 12a and the second battery cell 12b, a location between the second battery cell 12b and the third battery cell 12c, and a location between the third battery cell 12c and the fourth battery cell 12d, can be detected.

In the battery module 10 of Embodiment 1 having the above-described structure, as described previously, the current path 14 is configured to include the bus bars 16, and at least one of the bus bars 16 that form the current path 14 is provided with the voltage detection path part 26. That is, when the battery cells 12a to 12d are arranged in the first direction, the coupling parts 24 and 24 adjacent to each other in the first direction of the plurality of bus bars 16 in which the tab connection parts 22 are connected to the electrode tabs 20a and 20b are overlapped with and connected to each other, whereby the current path 14 is formed, and the voltage detection path parts 26 are formed. Accordingly, it is not necessary to use a separate member or the like in order to provide a voltage detection path, and an increase in and the number of components and the number of man-hours can be avoided. In particular, in Embodiment 1, the bus bars 16 that interconnect the battery cells 12a to 12d are provided with the voltage detection path parts 26, thus making it possible to detect voltages between the battery cells 12a to 12d.

In the battery module 10, the bus bars 16 that form the current path 14 are configured not to protrude outward of the electrode tabs 20a and 20b in the front-rear direction through the entire length thereof. Accordingly, an increase in the size of the assemblies 76a to 76d in the front-rear direction is avoided also when the electrode tabs 20a and 20b and the tab connection parts 22 are connected to each other, and thus an increase in the size of the battery module 10 can also be avoided.

In the bus bars 16 provided with the voltage detection path parts 26, as a result of the bus bars 16 being bent, the voltage detection path parts 26 are provided so as to protrude upward. This allows the voltage detection path parts 26 to be easily formed, and avoids an increase in the size of the assemblies 76a to 76d and hence the battery module 10 in the front-rear direction and the left-right direction due to the provision of the voltage detection path parts 26.

The battery module 10 may include a circuit board 42 to which the external connection parts 44 of the voltage detection path parts 26 are connected. This enables the voltage detection path parts 26 to be electrically connected to the circuit board 42 collectively with solder or the like, thus making it possible to avoid complex operations such as individually connecting voltage detection members or the like at voltage detection locations.

Each of the bus bars 16 is provided with the crank bent portion 27, and the coupling part 24 is spaced apart from the tab connection part 22 in the up-down direction by the crank bent portion 27. Accordingly, the coupling parts 24 can be located above or below the corresponding tab connection parts 22, and the coupling parts 24 and 24 that are adjacent to each other in the up-down direction can be stably overlapped with each other when coupling the assemblies 76a to 76d, thus making it possible to easily connect the coupling parts 24 by welding or the like.

The battery module 10 includes the accommodation cases 46a to 46d that separately accommodate the battery cells 12a to 12d, respectively, and the accommodation cases 46a to 46d are assembled so as to be overlapped with each other in the up-down direction, whereby the bus bars 16 are connected to form the current path 14. The bus bars 16 are held by the accommodation cases 46a to 46d in a state in which the bus bars 16 are partly embedded therein, and the electrode tabs 20a and 20b and the corresponding tab connection parts 22 are overlapped with and welded to each other, thus allowing the battery cells 12a to 12d to be handled as the assemblies 76a to 76d with the accommodation cases 46a to 46d. Accordingly, the bus bars 16, the power input bus bar 32, and the power output bus bar 36 will not be disassembled, thus making it possible to achieve a reduction in the number of components and improvement in assembly workability.

In Embodiment 1, the battery cells 12a to 12d stacked in the up-down direction are connected in series, and the current path 14 is configured to include the plurality of bus bars 16 (intermediate bus bars 38) disposed on the front and rear sides. That is, also in a case where a current path 14 that connect the battery cells 12a to 12d in series, the current path 14 does not extend linearly, but is configured to be folded back in the front-rear direction, and thus an increase in the size of the battery module 10 can be avoided.

### Embodiment 2

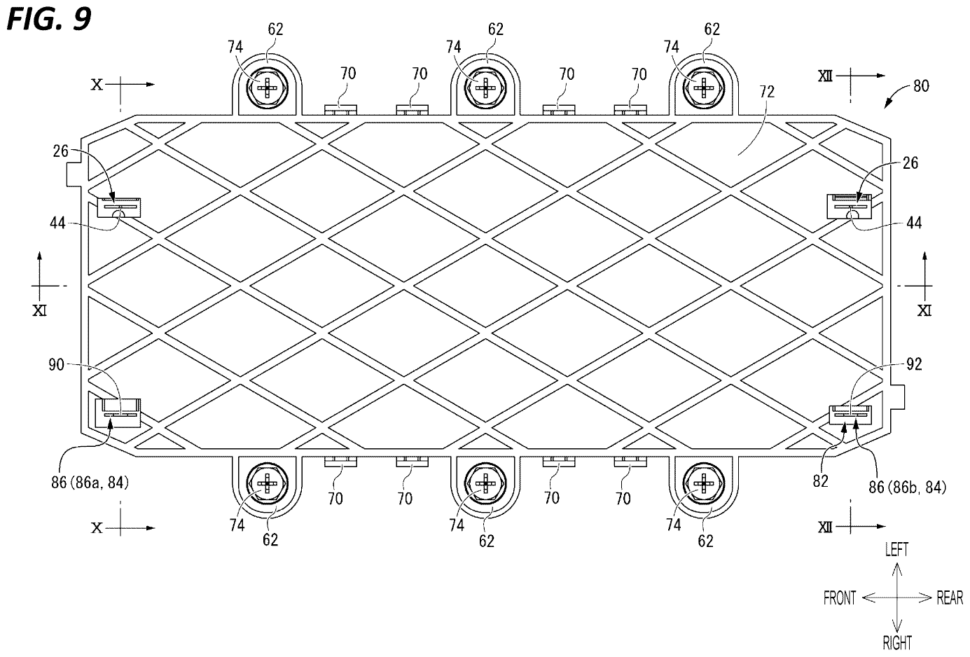

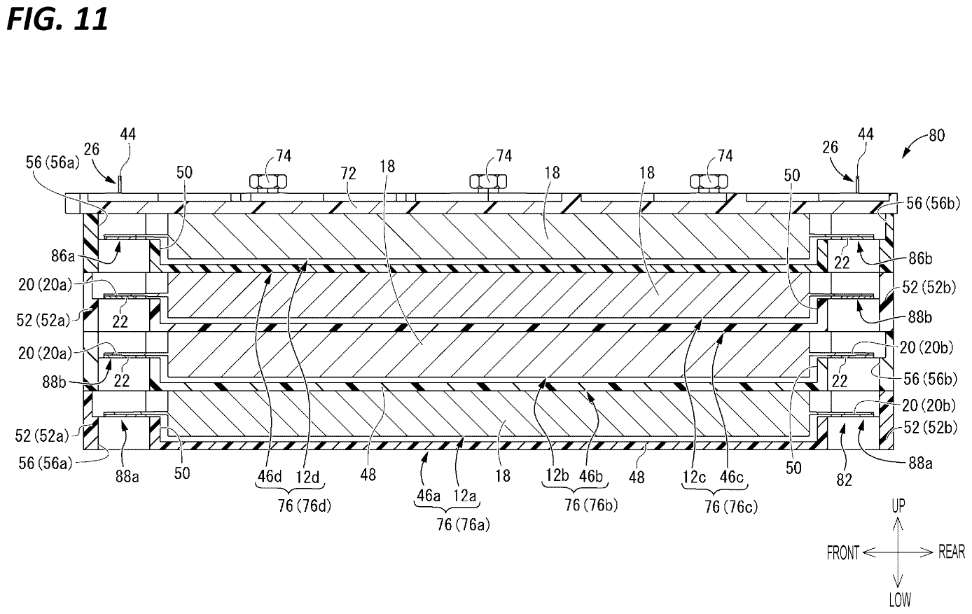

A battery module 80 according to Embodiment 2 of the present disclosure will be described below with reference to FIGS. 9 to 12. Although the basic configuration of the battery module 80 according to Embodiment 2 is the same as that of Embodiment 1, the battery cells 12a to 12d are connected in parallel in Embodiment 2. In the following description, members or portions that are substantially the same as those in Embodiment 1 are denoted by the same reference numerals as Embodiment 1 in the drawings, and detailed descriptions thereof have been omitted.

In Embodiment 2, a plurality of bus bars 84 that form a current path 82 include two end bus bars 86 (a front end bus bar 86a and a rear end bus bar 86b) constituting opposite ends of the current path 82, and a plurality of intermediate bus bars 88 that form a path connecting the end bus bars 86a and 86b to each other. That is, two of the eight bus bars connected to electrode tabs 20a and 20b of the battery cells 12a to 12d are the end bus bars 86a and 86b, and the remaining six bus bars are the intermediate bus bars 88.

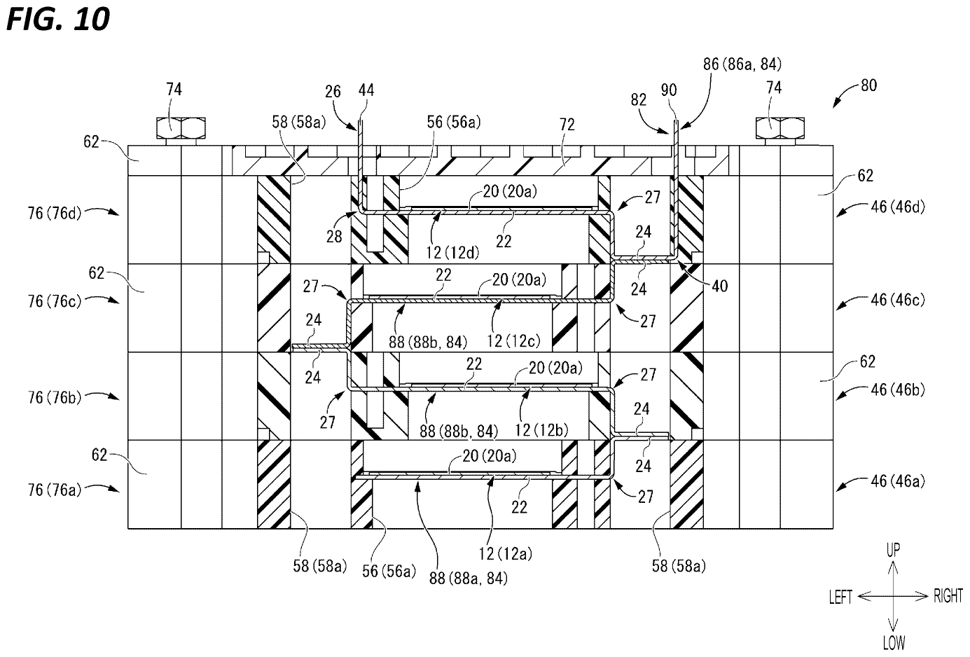

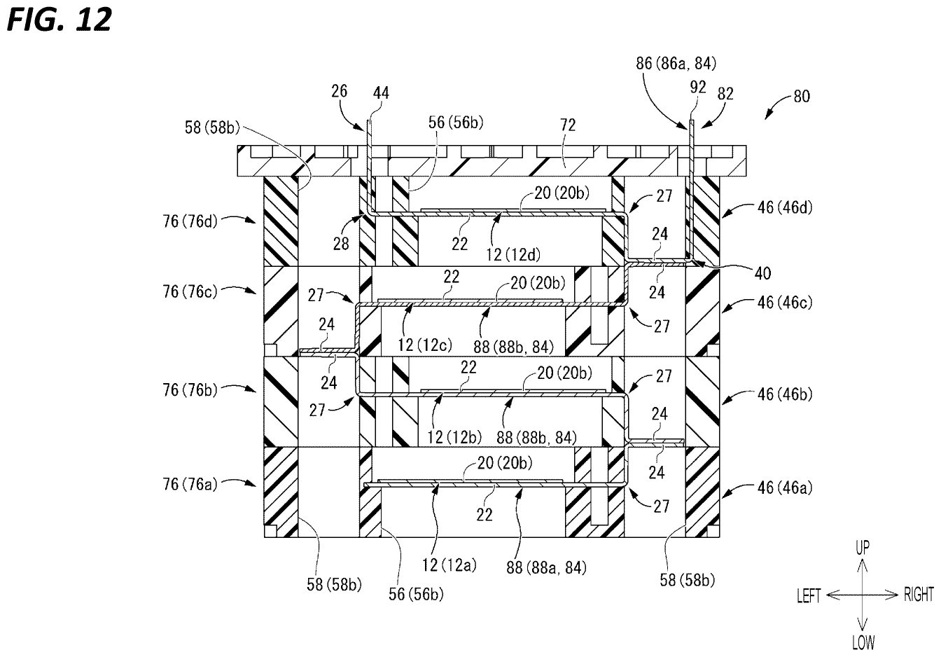

The end bus bars 86a and 86b each include a coupling part 24 and an external connection part on one (the right side in Embodiment 2) of opposite sides in the (left-right direction), and a voltage detection path part 26 on the other (the left side in Embodiment 2) of the opposite sides. Specifically, as shown in FIG. 10, the front end bus bar 86a includes a coupling part 24 and a power output part 90 as an external connection part protruding upward from the coupling part 24 at a right end portion thereof, and a voltage detection path part 26 at a left end portion thereof. As shown in FIG. 12, the rear end bus bar 86b includes a coupling part 24 and a power input part 92 as an external connection part protruding upward from the coupling part 24 at a right end portion thereof, and a voltage detection path part 26 at a left end portion thereof.

Among the intermediate bus bars 88, intermediate bus bars 88a on front and rear sides that are disposed the rearmost side (the lowermost side) each include a coupling part 24 on one side (the right side) in (the left-right direction), and four intermediate bus bars 88b other than the intermediate bus bars 88 each include coupling parts 24 on opposite sides in the (left-right direction). The coupling parts 24 and 24 adjacent to each other in the up-down direction of the end bus bars 86a and 86b and the intermediate bus bars 88a and 88b are connected to each other by welding or the like, whereby the current path 82 is formed, and the battery cells 12a to 12d are connected in parallel.

That is, the front electrode tabs 20a of the battery cells 12a to 12d are connected to each other by the three intermediate bus bars 88a and 88b, and the front end bus bar 86a that are disposed at the front of the battery module 80. The rear electrode tabs 20b of the battery cells 12a to 12d are connected to each other by the three intermediate bus bars 88a and 88b, and the rear end bus bar 86b that are disposed at the rear of the battery module 80. Also, the rear end bus bar 86b provided uppermost at the rear of the battery module 80 is provided with the power input part 92 and the voltage detection path part 26, and the front end bus bar 86a provided uppermost at the front of the battery module 80 is provided with the power output part 90 and the voltage detection path part 26.

In the battery module 80 according to Embodiment 2 that includes such a current path 82, the bus bars 84 (in particular, the end bus bars 86a and 86b) that form the current path 82 are also provided with the voltage detection path parts 26. Accordingly, the effects as those of Embodiment 1 can be achieved.

### Modifications

Although Embodiments 1 and 2 have been described above in detail as specific examples of the present disclosure, the present disclosure is not intended to be limited by the specific description. Modifications, improvements, and the like in a range in which the object of the present disclosure can be achieved are encompassed by the present disclosure. For example, the following modifications of the embodiments are also included in the technical scope of the present disclosure.

(1) In the above-described embodiments, the coupling parts 24 and 24 adjacent to each other in the up-down direction are connected to each other by being welded to each other. However, the coupling parts may be connected with solder, for example. Note that the connection between the coupling parts is not limited to the configuration in which the coupling parts are overlapped with and connected to each other in the up-down direction as described above. That is, all of the coupling parts provided on the bus bars may protrude upward, and soldered to the circuit board provided above the accommodation cases. Thus, the coupling parts may be electrically connected to each other via the electric circuit of the circuit board. In short, the coupling part electrically connected to each other may be spaced apart from each other without being overlapped with each other, or may be electrically connected to each other inside or outside the accommodation cases.

(2) In Embodiment 2 described above, of the four bus bars 84 respectively provided at the front and the rear, the bus bars 84 located uppermost are the front end bus bar 86a and the rear end bus bar 86b, and are provided with the output part 90, the power input part 92, and the voltage detection path parts 26. However, the present disclosure is not limited to this configuration. The power output part, the power input part, and the voltage detection path parts may be provided on those of the four bus bars on the front and rear sides other than the bus bars located uppermost.

(3) Although four battery cells 12a to 12d are provided in the above-described embodiments, the number of battery cells may be two, three, or five or more as long as a plurality of battery cells are provided.

(4) The shape of the accommodation cases that accommodate the battery cells is not limited. For example, the accommodation cases need not be provided with the leg parts, the lock pawl parts, and the lock frame parts.

### LIST OF REFERENCE NUMERALS

10 Battery module (Embodiment 1)
12 Battery cell
12a First battery cell
12b Second battery cell
12c Third battery cell
12d Fourth battery cell
14 Current path
16 Bus bar
18 Body part
20 Electrode tab
20a Front electrode tab
20b Rear electrode tab
22 Tab connection part
24 Coupling part
26 Voltage detection path part
27 Crank bent portion
28 Bent portion
30 Power input part
32 Power input bus bar
34 Power output part
36 Power output bus bar
38 Intermediate bus bar
40 Bent portion
42 circuit board
44 External connection part
46 Accommodation case
46a First accommodation case
46b Second accommodation case
46c Third accommodation case
46d Fourth accommodation case
48 Bottom wall
50 Body accommodating recess
52 Side wall part
52a Front side wall part
52b Rear side wall part
54 Connection wall part
56 Tab placement hole
56a Front tab placement hole
56b Rear tab placement hole
58 Coupling through hole
58a Front coupling through hole
58b Rear coupling through hole
60 Insertion hole
62 Leg part
64 Bolt insertion hole
66 Bolt hole
68 Lock pawl part
70 Lock frame part
72 Lid member
74 Fixing bolt
76 Assembly
76a First assembly
76b Second assembly
76c Third assembly
76d Fourth assembly
80 Battery module (Embodiment 2)
82 Current path
84 Bus bar
86 End bus bar
86a Front end bus bar
86b Rear end bus bar
88, 88a, 88b Intermediate bus bar
90 Power output part (external connection part)
92 Power input part (external connection part)

1. A battery module comprising:
a plurality of battery cells;
a pair of electrode tabs provided on each of the plurality of battery cells; and
a plurality of bus bars configured to be connected to the electrode tabs to form a current path that connect the plurality of battery cells, wherein
the plurality of battery cells are disposed so as to be aligned,
when a first direction is an arrangement direction of the plurality of battery cells,
the pair of electrode tabs protrude in a second direction that intersects the first direction,
the plurality of bus bars extend in a third direction that intersects the second direction in a plane constituting the second direction, and
each include a coupling part on at least one of opposite sides thereof in the third direction, and,
when the plurality of battery cells are disposed so as to be aligned, the plurality of bus bars form the current path, and a voltage detection path part is formed, via the coupling parts.

2. The battery module according to claim 1, wherein
the bus bars are connected to the electrode tabs such that a width direction of the bus bars is the second direction, and
a length of the bus bars in the second direction is greater than or equal to a length of the electrode tabs throughout the entire length of the bus bars.

3. The battery module according to claim 1, wherein
at least one of the plurality of bus bars includes the voltage detection path part on the one side or the other side of the opposite sides in the third direction,
the bus bars each include a tab connection part located between the opposite sides in the third direction and configured to be connected to the corresponding electrode tab, and
a portion between the tab connection part and the voltage detection path part of the bus bar provided with the voltage detection path part is bent in a plate thickness direction, and the voltage detection path part protrudes forward in the first direction.

4. The battery module according to claim 1, further comprising
a circuit board to which the voltage detection path part is configured to be conductively connected, wherein
the circuit board is disposed forward of the battery cell located most forward in the first direction, and
an external connection part provided at an end portion of the voltage detection path part on a front side in the first direction is connected to a conductive path of the circuit board.

5. The battery module according to claim 3, wherein
each of the bus bars is provided with a crank bent portion between the coupling part and the tab connection part in the third direction, and the coupling part is spaced apart from the tab connection part in the first direction by the crank bent portion.

6. The battery module according to claim 3, further comprising
a plurality of insulating accommodation cases that separately accommodate the plurality of battery cells, wherein
the accommodation cases each include: a body accommodating recess including a bottom wall opposed to a body part of the corresponding battery cell in the first direction so as to be open forward in the first direction; a pair of side wall parts provided on opposite sides of the corresponding body accommodating recess in the second direction; a pair of tab placement holes that penetrate the pair of side wall parts in the first direction and in which the pair of electrode tabs protruding on opposite sides of the body part accommodated in the body accommodating recess are placed, and coupling through holes that penetrate the pair of side wall parts in the first direction and in which the coupling parts of the bus bars are placed,
a portion of each of the bus bars is held in embedded on the corresponding side wall part, and the coupling part of the bus bar placed in the coupling through hole is exposed on at least one of opposite surfaces of the side wall part in the first direction,
the tab connection parts of the bus bars are placed in the tab placement holes of the side wall parts so as to be located inward of the opposite surfaces in the first direction, and the electrode tabs placed in the tab placement holes are overlapped with and connected to the tab connection parts, and,
as a result of the plurality of accommodation cases being overlapped and assembled together in the first direction, the coupling parts of the plurality of bus bars are overlapped with and connected to each other in the first direction to form the current path.

7. The battery module according to claim 1, wherein
the plurality of battery cells are connected in series,
a power input bus bar including a power input part is connected to one of the electrode tabs of the battery cell disposed most rearward in the first direction,
a power output bus bar including a power output part is connected to one of the electrode tabs of the battery cell located most forward in the first direction,
the plurality of bus bars include a plurality of intermediate bus bar that form a path that interconnects the power input bus bar and the power output bus bar of the current path, and
at least one of the intermediate bus bars includes the coupling part on one of the opposite sides, and includes the voltage detection path part on the other of the opposite sides.

8. The battery module according to claim 1, wherein
the plurality of battery cells are connected in parallel,
the plurality of bus bars include two end bus bars constituting opposite end portions of the current path, and a plurality of intermediate bus bars that form a path that interconnects the end bus bars of the current path,
each of the end bus bars includes the coupling part and an external connection part on one of the opposite sides, and includes a voltage detection path part on the other of the opposite sides,
the intermediate bus bars connected to the pair of the electrode tabs of the battery cell disposed most rearward in the first direction each include the coupling part on one of the opposite sides, and
the other intermediate bus bars each include the coupling part on one of the opposite sides, and also include the coupling part on the other of the opposite sides.
